(19) United States
(12) Patent Application Publication
(10) Pub. No.: US 2024/0330992 A1
(43) Pub. Date: Oct. 3, 2024

(54) SYSTEMS AND METHODS FOR ELECTRONIC DATA SECURITY CREATION, REVIEW, AND ACCESS APPROVAL

(71) Applicant: Honeywell International Inc., Charlotte, NC (US)

(72) Inventor: Ankit SINGH, Apex, NC (US)

(21) Appl. No.: 18/193,264

(22) Filed: Mar. 30, 2023

(51) Int. Cl. G06Q 30/0282; G06F 21/31

(52) U.S. Cl. CPC G06Q 30/0282; G06F 21/316

(57) ABSTRACT

A method of electronic document access approval including receiving an access request from a user to electronically access data; receiving a request from the user to indicate the data within the electronic file has been reviewed; determining whether the electronic file is configured to indicate having been reviewed by the user based on a generic certificate; determining a file review threshold security score, wherein the file review threshold security score is a minimum security score to permit the use of a generic certificate by any particular user to indicate review of the data; and determining whether the user can indicate review of the data using the generic certificate based on whether the electronic file is configured to indicate having been reviewed by the user based on the generic certificate and whether the user has a user security score that is greater than the file review threshold security score.

### TECHNICAL FIELD

The present disclosure relates to systems and methods for the automatic generation and display of electronic reports and more particularly to the automatic generation, collation, approval, and display of multiple electronic report segments and other data.

### BACKGROUND

Drafting, approval, and publishing of reports can require input from many departments within an organization. Each department may be responsible for one or more aspects, portions, or data within a report and the report could contain volumes of information. This is especially true in the pharmaceutical industry, where periodic product quality reviews and reports are required to meet product quality standards and regulatory requirements. One report required is the Annual Product Quality Review (APQR). APQRs require the collection, input, review, and approval of vast amounts of data related to all aspects of a pharmaceutical product or process's production, sale, and marketing. The collection, input, review, and approval of such vast amounts of data requires the time and effort from many subject matter experts (SMEs) who may review and approve the data prior to a report being published.

Meanwhile, information and network security requirements ensure that sensitive and/or proprietary data is properly safeguarded from unwanted publication or other dissemination, whether intentional or accidental. In some instances, there may be a friction between security requirements protecting information and the intentional publication of report data. An amount of data to be reviewed may be too large for a reviewer or team of reviewers to complete their review and approval before a deadline for internal or external publication. Accordingly, improvements to systems and methods of review of data, especially with respect to the review and approval of data may be required. The present application describes improved systems and methods for data creation, review, and approval.

The background description provided herein is for the purpose of generally presenting the context of the disclosure and the scope of the present application is not limited to capabilities to solve any problem or improvements to any process, but instead extends to the scope of the claims listed hereinbelow. Unless otherwise indicated herein, the materials described in this section are not prior art to the claims in this application and are not admitted to be prior art, or suggestions of the prior art, by inclusion in this section.

### SUMMARY

In one embodiment, a method of electronic document access approval, includes receiving a request from a user to electronically access data within an electronic file, the user being associated with a user profile stored in a user profile module that is communicatively coupled to an electronic document database storing the electronic file; receiving a request from the user to indicate the data within the electronic file has been reviewed, the review indication serving as authentication that the user has reviewed the data within the electronic file; determining whether the electronic file is configured to indicate having been reviewed by the user based on a generic certificate; determining a file review threshold security score, wherein the file review threshold security score is a minimum security score to permit the use of a generic certificate by any particular user to indicate review of the data; and determining whether the user can indicate review of the data using the generic certificate based on whether the electronic file is configured to indicate having been reviewed by the user based on the generic certificate and whether the user has a user security score that is greater than the file review threshold security score.

In another embodiment, a system for electronic document access approval includes an input/output device; a processor; and a memory storing one or more non-transitory, processor-readable instructions that, when executed by the processor, cause the system to: receive a request from a user to access data within an electronic file, the user being associated with a user profile stored in a user profile module that is communicatively coupled to a database storing the electronic file; receive a request from the user to indicate the data within the electronic file has been reviewed, the review indication serving as authentication that the user has reviewed the data within the electronic file; determine whether the electronic file is configured to indicate having been reviewed by the user based on a generic certificate; determine a file review threshold security score, wherein the file threshold security score is a minimum security score to permit the use of a generic certificate by any particular user to indicate review of the data; and determine whether the user can indicate review of the data using the generic certificate based on whether the electronic file is configured to indicate having been reviewed by the user based on the generic certificate and whether the user has a user security score that is greater than the file review threshold security score.

In yet another embodiment, a method of electronic document access approval includes receiving a request from a user to access data within an electronic file, the user being associated with a user profile stored in a user profile module that is communicatively coupled to a database storing the file; receiving a request from the user to indicate the data within the electronic file has been reviewed, the review indication serving as authentication that the user has reviewed the data within the electronic file; determining whether the electronic file is configured to indicate having been reviewed by the user based on an individual user certificate; determining a file review threshold security score, wherein the file review threshold security score is a minimum security score to not require use of the individual user certificate to indicate review of the data; and determining whether the user must indicate review of the data using the individual user certificate based on whether the electronic file is configured to indicate having been reviewed by the user based on one or more of the individual user certificate and a generic security certificate and whether the user has a user security score that is greater than the file review threshold security score.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

Embodiments of the disclosure will now be described, by way of example only, with reference to the accompanying drawings in which:

FIG. 1 illustrates an exemplary computing environment for implementing one or more of the systems and methods described herein.

FIG. 2A further illustrates aspects of the exemplary environment of FIG. 1.

FIG. 2B further illustrates aspects of the exemplary environment of FIGS. 1 and 2A.

FIG. 3 illustrates various aspects of the exemplary computing environment of FIG. 1.

FIG. 4 illustrates an exemplary computing environment including a CPU and multiple storage devices.

FIG. 5 is a flowchart depicting a method for automatically assigning one or more user permissions.

FIG. 6 is a second flowchart depicted a method for automatically assigning one or more user permissions.

### DETAILED DESCRIPTION

Document review, signature, and verification of signature are critical to ensuring that documents with accurate information are created. Verification of signatures can be difficult, especially in large organizations, because user accounts may be routinely created, updated with new information (e.g., user credentials, etc.), and/or deleted. Persistent turnover of personnel and, especially in some highly-regulated industries, ever evolving regulatory requirements make keeping account details and user profiles up to speed with deadlines difficult but crucial. Some organizations may give a credential to one or more users responsible for reviewing and verifying data accuracy. The reviewing users may thus all use the same credential, making it difficult to determine or verify which user reviewed/approved data after a review has occurred. Such an approach may make review more efficient, but also make illicit access easier for bad actors. Other organizations may require individual credentials be associated with data creation, review, and approval through each step in a data or document production and approval process. This may similarly prove unwieldy as it may require overwhelmingly resource levels of account creation and curation.

One such type of organization that may face this tradeoff is a pharmaceutical company, which may be regulated to provide periodic quality review reports of their various products and services. For example, a pharmaceutical company may be required to produce an Annual Product Quality Review (APQR) report that details quality information associated with its products. Such reports require input and editing from countless users from disparate departments, functions, and roles within a company. For example, a head of accounting may review and edit reports from his or her accounting personnel but may also be required to review and approve sales figures for a particular product from a sales department. Compounding the problem, users may tend to rotate roles within and without the organization due to events such as natural turnover in staff, promotions, hiring cycles, etc. Such turnover can require frequent updates to permissions and user account metadata, which may be untenable for a system administrator(s). Accordingly, systems and methods for a hybrid data review and approval process may be required.

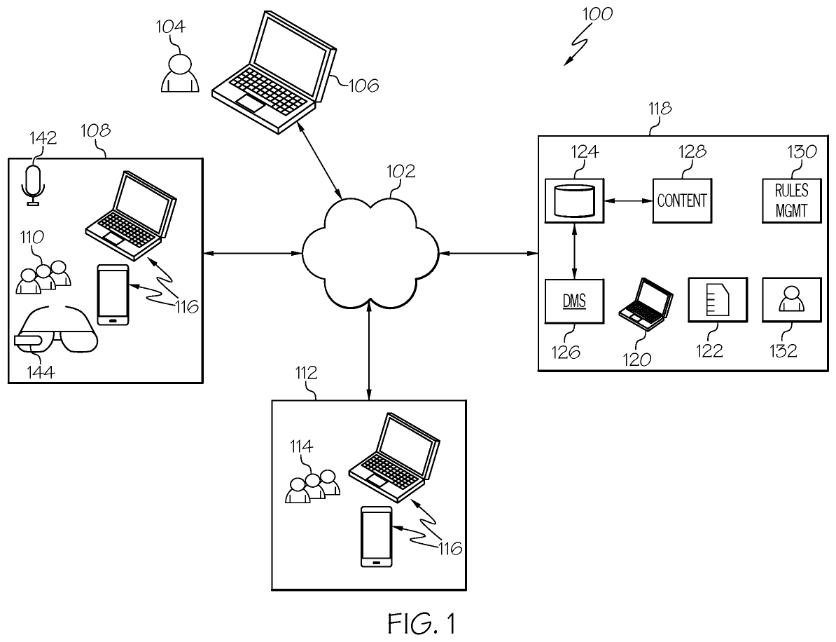

The following disclosure provides one or more systems and methods for tiered requirements for review and approval of data and for verifying such review and approval. Referring to FIG. 1, a system 100 for data creation, review, and approval is shown. The system 100 may include a plurality of nodes comprising one or more processing devices (e.g., personal computers, computer networks, personal devices, device networks, etc.) communicatively coupled to a network 102 via one or more communication interfaces (e.g., modem, router, transceiver, etc.) One or more users may be connected to the network 102. For example, an admin user 104 may connect to the network through an admin device 106. In embodiments, users may be grouped according to one or more similar characteristics. For example, the users may be grouped according to a department of the users, a primary geographical location of the users, a primary language of the users, etc. In some embodiments, a first grouping 108 may include one or more users 110 and a second grouping 112 may include one or more users 114. The users may connect to the network 102 via user devices 116. The users may each have individual access permissions and/or various groups of users may be assigned access permissions as will be described in greater detail herein. In some embodiments, the first grouping 108 and the second grouping 112 may be, for example, employees responsible for generating a first portion of a report, tenants accessing a multi-tenant database (e.g., a file management system) for which it may be efficient to create similar and/or common permissions, or some other type of organizational member. In other embodiments, the first grouping 108 and the second grouping 112 may be various departments or sectors of a singularly-controlled organization (e.g., a company, firm, etc.) for whom it may be efficient to create similar and/or common permissions (for example, because the each of the groups may be creating, editing, and reviewing similar types of data (e.g., sections of a report) within and amongst the group). These two types of groups are merely non-limiting examples and it is to be understood that the first grouping 108 and the second grouping 112 may have any relationship within the organization and that the organization may have any number of groups.

Still referring to FIG. 1, a file management system may include or be comprised on a document management server (DMS) 118, which DMS 118 may be communicatively coupled to the network 102. The DMS 118 may comprise one or more processing devices 120, one or more memory devices 122, one or more databases 124 (or repositories, content repositories, etc.), a quality management solution (QMS) module 126, a content module 128, a rules management module 130, and a user profile module 132. In some embodiments, one or more of the users 110 may provide inputs to the system 100 via one or more input devices. For example, the users 110 may provide input to the system 100 via an audible input 142 and/or a hands-free input 144. The audible input 142 may be communicatively coupled to, for example, software for understanding one or more speech inputs and the hands-free input 144 may be capable of receiving and providing to the system 100 one or more inputs based on visual and/or audible data (e.g., by scanning a QR code, etc.)

The network 102 may be used to transmit data from the various data processing devices to the server (e.g., a computer of any appropriate configuration) in an appropriate manner. For instance, the data processing device(s) and the server may communicate over a local area computer network (LAN) or a public computer network (e.g., the Internet). In some embodiments, the network 102 may be a private LAN and may be separated from the public Internet by, for example, a firewall. The information associated with assigning user permissions may be transmitted from the server to one or more of the nodes in any appropriate manner. For instance, the server and a node (e.g., a personal computer; a desktop computer; a laptop computer; a “dumb” terminal) at any location connected to the network may communicate over a computer network, such as a public computer network (e.g., the Internet). A web application may be used to view search results as well.

The one or more processors 120 may communicatively couple with the one or more memory devices to perform one or more of the computer-based methods described herein. The DMS 118 may enable users to manage one or more types of files such as, for example, text-based files, image-based files, charts, presentations, images, videos, sounds, and other types of files. The DMS 118 may present one or more interfaces including a query function, allowing users to search a connected database (e.g., an open source, distributed search and analytics tool) and may provide search results using a search engine that can conduct a search of the relevant databases communicatively coupled to a device of the user. In some embodiments, the relevant databases may be automatically selected for a given search based on a profile of the user (as determined, for example, with the user profile module 132). The automatically selected databases may be a default setting based on, for example, a profile of the user (e.g., to which department a user identity is assigned) and the selected databases may be configurable such that a user can decide which databases the user's queries search.

The QMS 126 may track and control a web of quality events, any one of which could trigger numerous parallel or downstream actions. Quality management may impact every area of the business, and as such quality data must be input and fed from each aspect of the business. The QMS 126 may, for example, reduce the time and risk of error associated with manual process reporting, provide consistent change control processes, speed up critical processes, resulting in greater efficiency overall, simplify finding and linking related records and quality events, improve Corrective Action Preventive Action (CAPA) management, provide auditable assurance that regulatory requirements are met, and give stakeholders and authorized users better visibility into quality across the organization. In some embodiments, the QMS 126 may be a separate or distinct system from the DMS 118.

The content module 128 may include one or more caches or containers for storing corporate documents and other content. For example, the content module 128 may include a repository of documents with text in one or more languages, each document being indexed for the one or more languages it includes text in. In some embodiments, one or more of the stored documents or data may relate to an Annual Product Quality Review (APQR) report. In embodiments, a content type may define how the content is stored in the content module 128. For example, business logic and methods, database structure, definitions (e.g., schema, field, table, etc.) and associated content of different content types may be stored in different manners, accordingly. Business logic and the methods of the module may be configured to act based on particular content items having been stored in the database (e.g., in the case of a particular visualizations or visualization data being stored in one or more aspects of the content module 128).

The rules management module 130 may administrate one or more Business rules for automatically assigning user permissions. The Business rules may define a user's permissions and how such permissions may be automatically assigned based on a user's security score as compared with a security threshold as explained in greater detail herein. In some embodiments, the Business rules may assign permissions to a user based on the metadata associated with the user's profile and/or according to various aspects of the user's profile. In some embodiments, the rules management module 130 or another module of the system may assign a user's security score based on a number of factors. For example, a user's security score may be based on a number of years of service of a user (e.g., a document approver) in the company/department for which he or she will be editing/reviewing/approving documents, a number of documents approved within a given amount of time, a number of the times the user has changed departments, an internal security trust score for a given user (e.g., as determined by an outside or tenant organization and assigned to the user by the outside or tenant organization), a number of times a document or portion of a document which the user controls (or owns) is flagged for security risks, a number of audits and/or audit correlation to security score per client (may be different per client), a number of years a user has occupied a given role (e.g., a Review Project Manager), a list of security credentials required for a given customer and/or tenant, a list of attained security credentials for the user (e.g., Professional, Certified Information Systems Security Professional (CISSP), Certified Information Security Manager (CISM), etc.), a product type (e.g., some product types may require relatively lower or higher level of security), etc.

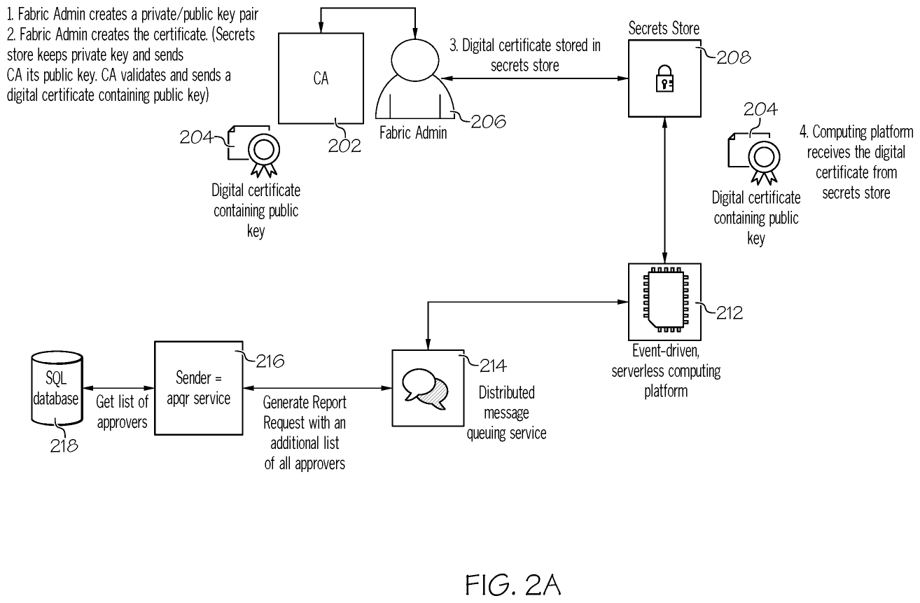

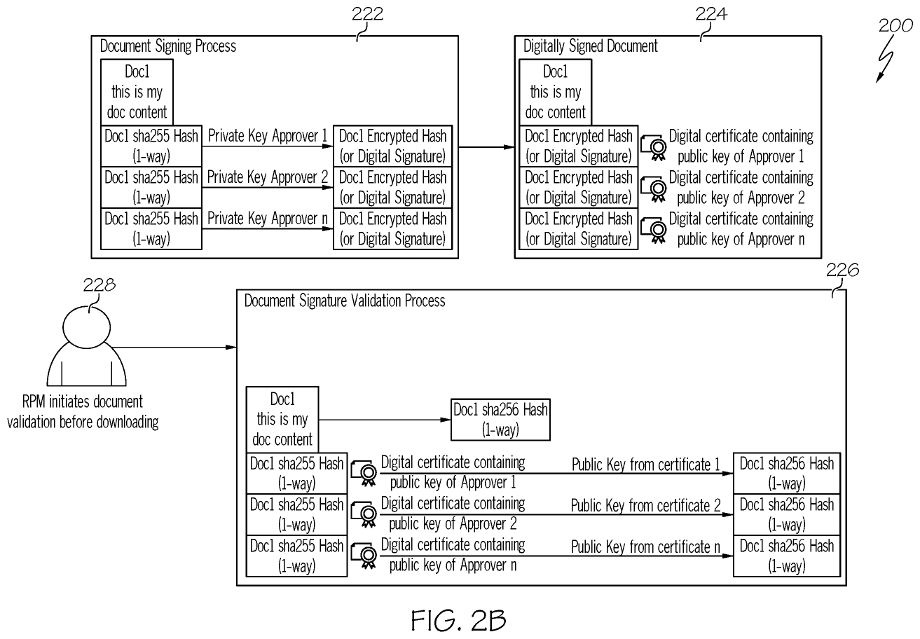

The user profile module 132 may collect or receive user profile information from the various users of the systems. The user profile module 132 may store one or more certificates associated with the users of the system 100. In some embodiments, the user profile information includes information about the user such as the user's department, the user's role (job function, etc.) within the department or larger organization as a whole, a current or typical location of the user, various certifications or accreditations of a user, or other information. In some embodiments, the user may update information associated with his or her profile individually. For example, a user may input his or her location, accumulated experience, department information, etc., when creating his or her own user profile (e.g., by selecting from amongst various selections in a drop down) or may assign one or more filters temporarily to his or her profile. For example, if a user knows that they require access to or approval authority for documents or data related to a certain topic at a particular permission level, the user could add such permission or request to add such permission to their profile subject to user admin approval and the permission could affect the Business rules associated with the user profile. User profile information may be collected and stored in a database, for example, a permissions database 218 of FIG. 2 (described in greater detail herein) which permissions database, referring again to FIG. 1, could be stored at the database(s) 124 or other aspect of the system 100. In some embodiments, user profile information can include, for example, one or more user credentials, an identity of the user, a department assigned to the user, a duration of employment, or other user identifying information.

Additionally, the user profile module 132 may maintain a list of typical user profiles or access permissions and may align a user's permissions based on the maintained list of typical user profiles or access permissions. For example, if a brand new user typically does not have access to read/write any documents to the system, the user profile module may automatically assign the typical access permissions to the profile based on the length the profile has been created. The list of typical access permissions is described in greater detail herein. The user profile module 132 may further include one or more aspects for managing user access permissions for example, the user profile module 132 may include one or more identity and access management (IAM) functions. The IAM functions could be enacted using, for example, a connection to one or more IAM databases (e.g., in the database(s) 124). The IAM function could be configured to communicate with other aspects of the system 100 using, for example, one or more connections via the network 102. The IAM function could use an IAM database to store, parse, categorize, or take other actions, for example, access rules, restriction requirements, management information, collected data, correlated data, predication data, behavioral information, and other suitable information, or any combination thereof. Further, the IAM function could dynamically restrict authorized users and access attempts if such users or access attempts occur when the IAM function may vulnerabilities or behaviors that are deemed hostile to the network 102. Accordingly, the IAM function and its use of tracking and monitoring behaviors over a long period of time could provide an added measure of security to any pre-defined policies followed by systems or subsystems communicatively coupled with the IAM function. In some embodiments, the IAM function may restrict access to particular data (e.g., data in a particular language, business analytics data, etc.) or documents or data based on, for example, a department of a user or other aspect of a user's profile.

The database 124 may be a NoSQL database, for example, or another type of database. The database 124 may include one or more applications or interfaces which enable the creation, selection, import, etc. of database tables that can store and retrieve any data and serve various levels of request traffic. In some embodiments, the database 124 may include one or more applications for monitoring resource utilization and/or performance metrics associated with the database 124 such that users (e.g., an admin user) can monitor resource utilization and performance metrics. The database 124 may include one or more backup databases or archives (e.g., for regulatory compliance, etc.)

Referring to FIGS. 2A and 2B, an exemplary environment 200 for automatically determining a certificate level required for signing a document and subsequently signing and verifying signature of the document is shown. The environment 200 can include a certificate authority (CA) 202, which may issue one or more digital certificates 204. A fabric admin 206 may interact with one or more of the aspects of the environment 200. For example, the CA 202 and the secrets store module 208. The fabric admin 206 may create, for example, a generic security certificate, which may be used to sign and verify signatures of a user for documents based on a security score of the user as described in greater detail herein. The secrets store module 208 may be communicatively coupled to the CA 202 and/or the computing platform 212, which may be communicatively coupled to a message queuing service 214, which may be communicatively coupled with a document signing microservice module 216 (e.g., an APQR signing microservice). The document signing microservice module 216 may receive one or more data inputs from an SQL database 218.

The CA 202 may be a trusted entity that issues Secure Sockets Layer (SSL) certificates. These digital certificates may cryptographically link an entity (e.g., a user, group of users, a tenant, a customer, etc.) with a public key. The fabric admin 206 may have various tasks such as, for example, assigning authorized user IDs and passwords, assigning authorization levels and/or individual permissions to users, generating one or more generic security certificates, and other tasks. The fabric admin 206 may access and control user permissions using, for example, a user admin interface. In the particular environment 200 shown, the fabric admin 206 may create one or more private/public key pairs and one or more digital certificates. The fabric admin 206 may provide the private/public key pair to a secrets store module 208, which may retain the private key and send the public key to the CA 202, which may validate the public key and provide the secrets store module 208 a digital certificate 204 including the public key. The digital certificate 204 including the public key may be provided to the computing platform 212 by the secrets store module 208 and the computing platform 212 may receive the digital certificate 204. Digital certificates may be obtained for each user on a list of approvers as obtained from a database (e.g., the SQL database 218).

In some embodiments, the computing platform 212 may be an event-driven, serverless computing platform. Events may be, for example, changes in state of one or more data or types of data. For example, an event may include a report generation request which requests may be placed in the queuing service module. The events are then selected and implemented by the queuing service in due course. The event-driven computing environment can consist of agents (i.e., event emitters), sinks (i.e., event consumers), and event channels. Emitters have the responsibility to detect, gather, and transfer events. An Event Emitter does not know the consumers of the event, it does not even know if a consumer exists, and in case it exists, it does not know how the event is used or further processed. Sinks have the responsibility of applying a reaction as soon as an event is presented. The reaction might or might not be completely provided by the sink itself. The computing platform 212 may run code in response to events (e.g., requests from the secrets store module 208 and/or the distributed message queuing service 214) and automatically manages the computing resources required by that code. The distributed message queuing service 214 and the computing platform 212 may process asynchronous tasks in distributed architectures.

Based on receiving the digital certificate, the computing platform 212 may update the distributed message queuing service and a report may be received with a list of all approvers. The list of all approvers may come from, for example, a database 218, which may be an SQL database.

FIG. 2B shows an exemplary process for signing and validating a document signature using the system and methods described herein. At block 222, a document signing process may occur. The document signing process may include generating a digest with data (“Doc1”) and the user's private key (as generated by the certificate authority, for example). The data can be, for example, a report (e.g., an APQR) or a portion thereof. Any number of approvers could potentially review a document, provided they have user profiles saved and stored (e.g., in the user profile module 132 of FIG. 1). The document may be signed and combined with the user's certificate, which may contain his or her public key, as a digitally signed document verifying review by the signer (e.g., a subject matter expert responsible for generating and approving the content of a report including the data (e.g., the APQR)) at block 224.

At block 226, a responsible program manager 228 may validate a document before downloading the same in order to validate the signature associated with the information in the document. The RPM 228 may decrypt the digest of the hashed document using the public key of the signer (as included with the signer's digital certificate). The decrypted digest (i.e., decrypted signed data) may be compared with the hashed original data. If the comparison of the decrypted signed data and the hashed original data is equivalent, the signature of the user is valid and it can be reasonably assumed that the user associated with that signature reviewed and approved the data. Hence, the RPM 228 validates the signature of the SME who created/reviewed the document. In some embodiments, the data may be signed using a generic signature instead of a private key of a review/approver at block 222. In such cases, the signer must have a security score above a threshold security score as explained in greater detail herein.

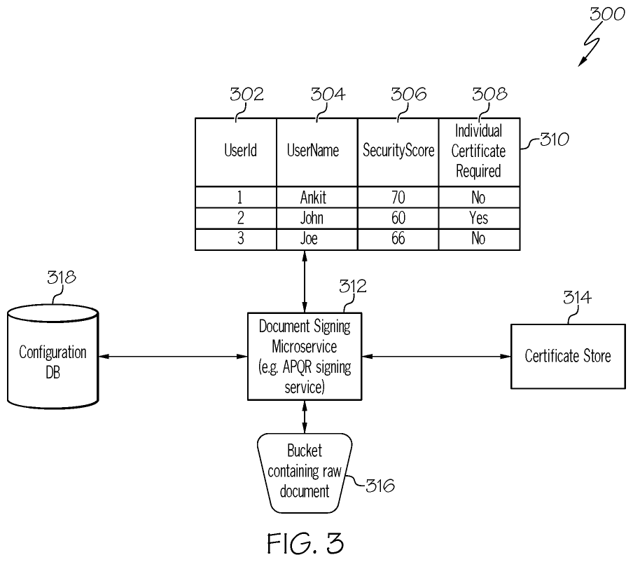

Referring now to FIG. 3, an exemplary environment 300 for determining whether or not a user can use a common or generic certificate or whether the user needs to digitally sign documents using an individual certificate is shown. The environment 300 shows a table 310 including data which could be used to determine an individual's security score. The table 310 may include, for example, a user id number 302, a user name 304, a user security score 306, and an individual certificate requirement 308. The environment 300 further includes a configuration database 318, a document signing micro service 312, a certificate store 314, and one or more storage locations 316 (for example, a bucket containing raw documents) for files requiring approval. The individual security score 306 may be based on or derived from various factors, such as, for example, a user's security score may be based on a number of years of service of a user (e.g., a document approver) in the company/department for which he or she will be editing/reviewing/approving documents, a number of documents approved within a given amount of time, a number of the times the user has changed departments, an internal security trust score for a given user (e.g., as determined by an outside or tenant organization and assigned to the user by the outside or tenant organization), a number of times a document or portion of a document which the user controls (or owns) is flagged for security risks, a number of audits and/or audit correlation to security score per client (may be different per client), a number of years a user has occupied a given role (e.g., a Review Project Manager), a list of security credentials required for a given customer and/or tenant, a list of attained security credentials for the user (e.g., Professional, Certified Information Systems Security Professional (CISSP), Certified Information Security Manager (CISM), etc.), a product type (e.g., some product types may require relatively lower or higher level of security), etc.

The user's security score 306 may be compared to a threshold score (assigned as 65 in the current example (but this is merely one non-limiting example and the threshold could be any number), and the comparison may be used to determine whether or not the individual user's certificate is required when the user reviews and/or approves documents. If the individual's specific certificate is not required, the user may use the common certificate.

The configuration database 318 may include data used to calculate an individual's security score and edit the score and/or the threshold score based on certain criteria. The score can go up and/or down based on one or more of the factors listed above or other factors. The user's score and/or threshold score can be calculated differently based on the content of the document/data for which a signature is being verified. In some embodiments, the threshold security score may be based on the content of a document and all of the users with authority to approve the document's content may need a security score above the threshold security score in order for the generic certificate to be used to sign and verify signature with respect to the document.

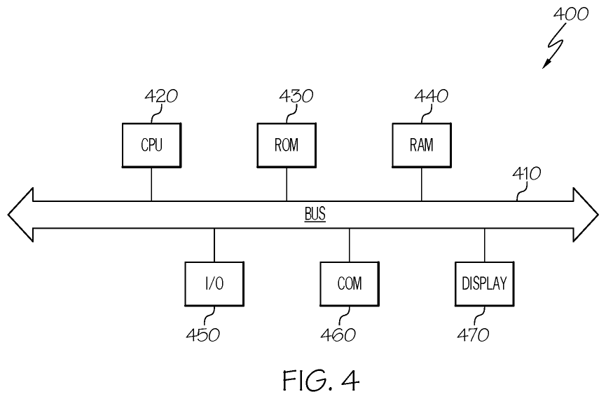

FIG. 4 is a simplified functional block diagram of a computing system 400 that may be configured for carrying out one or more of the steps, programs, and/or executing techniques described herein, according to exemplary embodiments of the present disclosure. Specifically, in one embodiment, any of the modules of the system 100 may be an assembly of software and/or hardware including, for example, a data communication interface 460 for packet data communication. The platform may also include a central processing unit (“CPU”) 420, in the form of one or more processors, for executing program instructions. The platform may include an internal communication bus 410, program storage, and data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. The system 400 may include one or more displays, such as display 470, for displaying information. Of course, the various system functions may be implemented in a distributed fashion on a number of similar platforms, to distribute the processing load. Alternatively, the systems may be implemented by appropriate programming of one computer hardware platform.

Any suitable system infrastructure may be put into place to allow for the assessment of models monitoring devices. FIG. 4 and the following discussion provide a brief, general description of one example of a suitable computing environment in which certain embodiments and aspects thereof the present disclosure may be implemented. In one embodiment, any of the disclosed systems, methods, and/or graphical user interfaces may be executed by or implemented by a computing system consistent with or similar to that depicted in FIG. 4. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

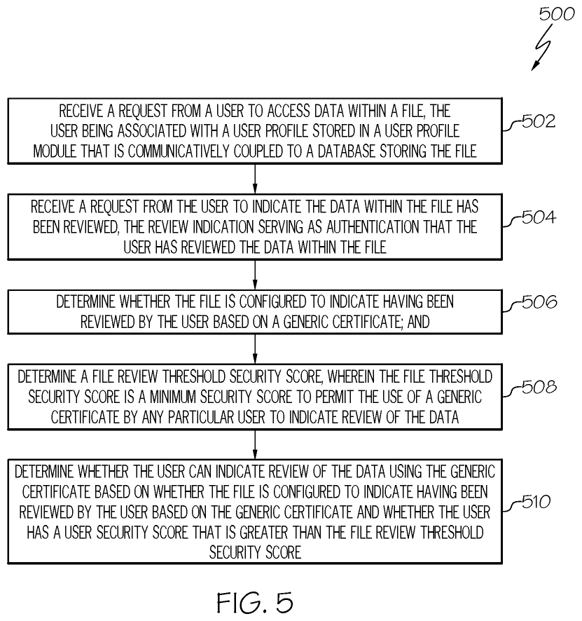

Referring to FIG. 5, a method 500 for determining whether a user can indicate review of data using a generic certificate or whether the user must indicate review of data using a private certificate is shown. The method 500 includes the various steps listed therein but it is to be understood that methods having fewer or more steps that that shown in FIG. 5 are contemplated herein.

At step 502, a request from a user to access data within a file may be received. The user may be associated with a user profile stored in a user profile module that is communicatively coupled to a database storing the file. The data can be, for example, data associated with an APQR report. The user may be accessing the data in order to edit and/or approve the data in order to edit a final report including the data. The user may be, for example, a subject matter expert or a reviewing program manager responsible for generating accurate data for the report and/or verifying the accuracy of data in the report.

At step 504, a request from the user to indicate the data within the file has been reviewed may be received. The review indication may serve as authentication that the user has reviewed the data within the file and thus had the opportunity to cause the data to be edited and/or approve the data. In the case that the user is a reviewing program manager, he or she may user their digital signature or a generic digital signature to verify the data has been reviewed.

At step 506, it may be determined whether the file is configured to indicate having been reviewed by the user based on a generic certificate. Because not all documents will be configured for indication of review using a generic certificate, it may be initially determined at the outset whether or not the document or data can be reviewed using the generic security certificate or not. If the generic security certificate is not acceptable for a particular document or data, there may be no need to perform further steps to determine whether an individual certificate must be used as this may already be required. However, if the generic security certificate is acceptable for a given document or data, the user must still be above a threshold to use the generic certificate.

Accordingly, at step 508, a file review threshold security score may be determined. The file threshold security score may be a minimum security score to permit the use of a generic certificate by any particular user to indicate review of the data. The threshold security score may be different for each type of document reviewed. For example, a quality events report may require a first threshold security score, while a pharmaceutical trials report may require a second threshold security score. These are, of course, merely non-limiting examples. Additionally, the threshold security score may be different for different reviewers. For example, a subject matter expert may have a threshold security score of X, while a reviewing program manager may have a threshold security score of Y. These are, or course, merely non-limiting examples. Users can have their threshold security score changed based on a number of factors, as listed herein.

At step 510, whether the user can indicate review of the data using the generic certificate may be determined. The determination of whether the user can indicate review of the data using the generic certificate may be based on whether the file is configured to indicate having been reviewed by the user based on the generic certificate and whether the user has a user security score that is greater than the file review threshold security score, that is, based on a comparison of the user's individual security score with the threshold security score. The individual user's security score may be calculated based on a number of factors as described otherwise herein. Hence, if a document is configured to such that it cannot indicate having been reviewed by a user using the generic security score or the reviewing user does not have a security score above the threshold security score, the document must be reviewed using an individual security certificate.

If the document is configured to indicate having been reviewed using the generic security certificate but the user does not have a score above the threshold security score, the document must be reviewed by the user using his or her particular digital certificate, as explained hereinabove, especially with respect to FIG. 2. This process of requiring individual security certificate validation provides some accountability while also allowing for efficient review of documents and data needed for reports. That is, users who have achieved sufficient knowledge, skills, abilities and/or experience generating and approving reports (as witnessed generally by the individual's security score), will be capable of reviewing documents using the generic certificate, saving the time and resources of needing to generate new individual certificates for these users. However, users without such capabilities will need to indicate approval of report content using their own certificate.

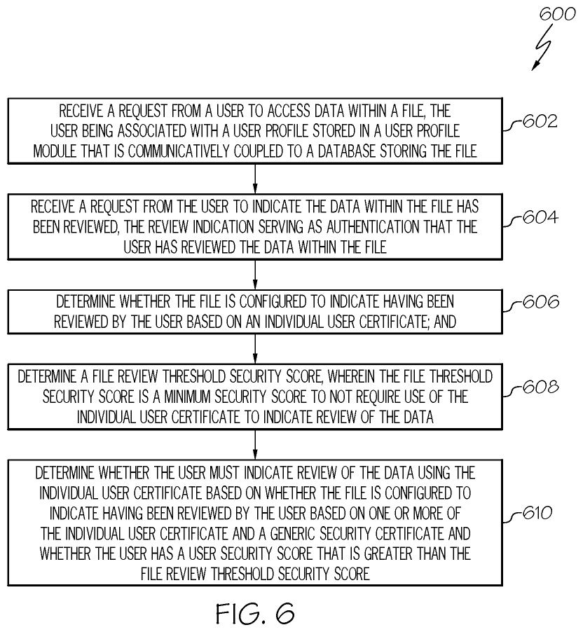

Referring to FIG. 6, another method 600 for selecting a user certificate or a common certificate based on an individual user security score is shown. The method 600 includes the various steps listed therein but it is to be understood that methods having fewer or more steps that that shown in FIG. 6 are contemplated herein.

At step 602, a request from a user to access data within a file may be received. The user may be associated with a user profile stored in a user profile module that is communicatively coupled to a database storing the file. The data can be, for example, data associated with an APQR report. The user may be accessing the data in order to edit and/or approve the data in order to edit a final report including the data. The user may be, for example, a subject matter expert or a reviewing program manager responsible for generating accurate data for the report and/or verifying the accuracy of data in the report.

At step 604, a request from the user to indicate the data within the file has been reviewed may be received. In embodiments, the indication of the user's review with a certificate may serve as authentication that the user has reviewed the data within the file. The certificate may contain, for example, a public key of the user. And a private key may be stored in a certificate store (e.g., the secrets store 208 of FIG. 2A). The review indication may serve as authentication that the user has reviewed the data within the file and thus had the opportunity to cause the data to be edited and/or approve the data. In the case that the user is a reviewing program manager, he or she may user their digital signature or a generic digital signature to verify the data has been reviewed.

At step 606, it may be determined whether the file or data is configured to indicate having been reviewed by the user based on an individual user certificate. Some documents may not be configured for review by a generic certificate. some documents may only be configured for review by individual certificates based on, for example, a sensitivity of the document or its content. Because not all documents will be configured for indication of review using a generic certificate, it may be initially determined at the outset whether or not the document or data can be reviewed using the generic security certificate or not. If the generic security certificate is not acceptable for a particular document or data, there may be no need to perform further steps to determine whether an individual certificate must be used as this may already be required. However, if the generic security certificate is acceptable for a given document or data, the user must still be above a threshold to use the generic certificate.

At step 608, a file review threshold security score may be determined. The file review threshold security score may be a minimum security score to not require use of the individual user certificate to indicate review of the data contained in the document. The threshold security score may be different for each type of document reviewed. For example, a quality events report may require a first threshold security score, while a pharmaceutical trials report may require a second threshold security score. These are, of course, merely non-limiting examples. Additionally, the threshold security score may be different for different reviewers. For example, a subject matter expert may have a threshold security score of X, while a reviewing program manager may have a threshold security score of Y. These are, or course, merely non-limiting examples. Users can have their threshold security score changed based on a number of factors, as listed herein.

At step 610, it may be determined whether the user must indicate review of the data using the individual user certificate based on whether the file is configured to indicate having been reviewed by the user based on one or more of the individual user certificate and a generic security certificate and whether the user has a user security score that is greater than the file review threshold security score.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A method of electronic document access approval, comprising:
receiving a request from a user to electronically access data within an electronic file, the user being associated with a user profile stored in a user profile module that is communicatively coupled to an electronic document database storing the electronic file;
receiving a request from the user to indicate the data within the electronic file has been reviewed, the review indication serving as authentication that the user has reviewed the data within the electronic file;
determining whether the electronic file is configured to indicate having been reviewed by the user based on a generic certificate;
determining a file review threshold security score, wherein the file review threshold security score is a minimum security score to permit the use of a generic certificate by any particular user to indicate review of the data; and
determining whether the user can indicate review of the data using the generic certificate based on whether the electronic file is configured to indicate having been reviewed by the user based on the generic certificate and whether the user has a user security score that is greater than the file review threshold security score.

2. The method of claim 1, wherein the threshold security score for the data is a portion of an annual product quality review report.

3. The method of claim 1, wherein the user security score is based on one or more certifications held by the user.

4. The method of claim 1, wherein the generic certificate comprises a private and public key pair.

5. The method of claim 1, wherein the user security score is based on a length of time the user security score has been established.

6. The method of claim 1, wherein the user security score is based on a role of the user within the system.

7. The method of claim 6, wherein a capability to use the generic security certificate is based on an internal security trust score for a given user.

8. The method of claim 1, wherein the file is assigned a certification requirement at a time of file creation.

9. The method of claim 1, further comprising:
receiving a request from a user to indicate the data within the electronic file has been approved, the approval indication serving as authentication that the user has approved the data within the file;
determining whether the file is configured to indicate having been approved by the user based on a generic certificate;
determining a file approval threshold security score, wherein the file threshold security score is a minimum security score to permit the use of a generic certificate by any particular user to indicate approval of the data; and
determining whether the user can indicate approval of the data using the generic certificate based on whether the electronic file is configured to indicate having been approved by the user based on the generic certificate and whether the user has a user security score that is greater than the file approval threshold security score.

10. The method of claim 9, wherein the file review threshold security score and the file approval threshold security score are different scores.

11. A system for electronic document access approval comprising:
an input/output device;
a processor;
a memory storing one or more non-transitory, processor-readable instructions that, when executed by the processor, cause the system to:
receive a request from a user to access data within an electronic file, the user being associated with a user profile stored in a user profile module that is communicatively coupled to a database storing the electronic file;
receive a request from the user to indicate the data within the electronic file has been reviewed, the review indication serving as authentication that the user has reviewed the data within the electronic file;
determine whether the electronic file is configured to indicate having been reviewed by the user based on a generic certificate;
determine a file review threshold security score, wherein the file threshold security score is a minimum security score to permit the use of a generic certificate by any particular user to indicate review of the data; and
determine whether the user can indicate review of the data using the generic certificate based on whether the electronic file is configured to indicate having been reviewed by the user based on the generic certificate and whether the user has a user security score that is greater than the file review threshold security score.

12. The system of claim 11, wherein the association between the user and the user profile is verified with a two-step authentication requiring at least two factors of authentication to authenticate a user.

13. The system of claim 12, wherein one or more of the factors of the two-step authentication include knowledge, possession, and inherence.

14. The system of claim 11, wherein the threshold security score for the data is a portion of an annual product quality review report.

15. The system of claim 11, wherein the user security score is based on one or more certifications held by the user.

16. The system of claim 11, wherein the generic certificate comprises a private and public key pair.

17. A method of electronic document access approval comprising:
receive a request from a user to access data within an electronic file, the user being associated with a user profile stored in a user profile module that is communicatively coupled to a database storing the file;
receive a request from the user to indicate the data within the electronic file has been reviewed, the review indication serving as authentication that the user has reviewed the data within the electronic file;
determine whether the electronic file is configured to indicate having been reviewed by the user based on an individual user certificate; and
determine a file review threshold security score, wherein the file review threshold security score is a minimum security score to not require use of the individual user certificate to indicate review of the data;
determine whether the user must indicate review of the data using the individual user certificate based on whether the electronic file is configured to indicate having been reviewed by the user based on one or more of the individual user certificate and a generic security certificate and whether the user has a user security score that is greater than the file review threshold security score.

18. The method of claim 17, wherein the threshold security score for the data is a portion of an annual product quality review report.

19. The method of claim 17, wherein the user security score is based on one or more certifications held by the user.

20. The method of claim 17, wherein the generic certificate comprises a private and public key pair.
